(19) United States
(12) Patent Application Publication
(10) Pub. No.: US 2012/0141164 A1
(43) Pub. Date: Jun. 7, 2012

(54) APPARATUS FOR DECOUPLING A ROLLER CHARGER FROM A PHOTOCONDUCTOR

(76) Inventors: Jeffrey Allan Pitas, Macedon, NY (US); David McLaughlin Rakov, Rochester, NY (US); Richard G. Luther, Hamlin, NY (US)

(21) Appl. No.: 12/959,470

(22) Filed: Dec. 3, 2010

(51) Int. Cl. G03G 21/18

(52) U.S. Cl. 399/115

(57) ABSTRACT

An apparatus for engaging and disengaging an imaging member from a photoconductor includes a shield enclosing the photoconductor. A detent on the shield to maintains a space between the imaging member and the photoconductor. Removing the shield allows the imaging member to move into contact with the photoconductor when the photoconductor and shield are inserted into an electrophotographic apparatus.

### CROSS REFERENCE TO RELATED APPLICATIONS

Reference is made to commonly-assigned copending U.S. patent application Ser. No. __/___,___ (Attorney Docket No. 96607/NAB), filed herewith, entitled DISENGAGING AN IMAGING MEMBER FROM A PHOTOCONDUCTOR, by Pitas et al.; the disclosure of which is incorporated herein.

### FIELD OF THE INVENTION

The invention relates to electrophotographic printing in general, and in particular to a shield for a photoconductor.

### BACKGROUND OF THE INVENTION

An electrophotographic printer uses sensitive components that must be routinely serviced by either dedicated service personnel or by the end user. Many of these components are easily damaged unless care is exercised during replacement. In some instances, it is considered imprudent to depend upon an individual exercising care as a step in carrying out a critical operation. This is especially important when the risk of error is high and the cost and machine down-time associated with error is great.

A primary component requiring frequent replacement within an electrophotographic print engine is the photoreceptive member. The function of the photoreceptive member is to provide a means of developing an image and transferring that image to paper. The photoreceptive member is coated with a photosensitive material which is essential to operation of the electrographic printer. The photosensitive material is easily scratched and can be damaged by exposure to ambient light if handled incorrectly.

In addition, components that normally come in contact with the photoreceptor may themselves become damaged by or do damage to the photoreceptor if they remain in contact for a prolonged period of time. This type of damage creates unacceptable image quality defects in the transferred image. Some prior art designs incorporate black paper as a means of separation of imaging components from the photoreceptive member. The black paper is wrapped tightly around the photoreceptor during replacement of the photoreceptor in the electrophotographic printer. A disadvantage of black paper is that the components are loaded against the paper such that when the paper is removed, an abrasive action occurs between the imaging member and photoreceptor. Rollers and cleaning blades may also become mechanically deformed, impairing proper function.

A means to decouple components from the photoreceptor would be desirable.

### SUMMARY OF THE INVENTION

Briefly, according to one aspect of the present invention an apparatus for engaging and disengaging an imaging member from a photoconductor includes a shield enclosing the photoconductor. A detent on the shield to maintains a space between the imaging member and the photoconductor. Removing the shield allows the imaging member to move into contact with the photoconductor when the photoconductor and shield are inserted into an electrophotographic apparatus.

The invention and its objects and advantages will become more apparent in the detailed description of the preferred embodiment presented below.

### BRIEF DESCRIPTION OF THE DRAWINGS

FIG. 1 is a schematic cross-section of a replacement cartridge.

FIG. 2 is a cross-section of a replacement cartridge in an electrophotographic printer with protective guards according to the present invention.

FIG. 3 is a replacement cartridge with protective guards removed.

FIG. 4 is a detail of a charging device separated from a photoreceptor within a replacement cartridge.

FIG. 5 is a detail of a charging device engaged to a photoreceptor within a replacement cartridge.

FIG. 6 is a detail of a cleaning device separated from a photoreceptor within a replacement cartridge.

FIG. 7 is a detail of a cleaning device engaged to a photoreceptor within a replacement cartridge.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

An electrophotographic printer includes components necessary to accomplish the task of printing an image on paper. Various sub-assemblies of the printer perform specific functions.

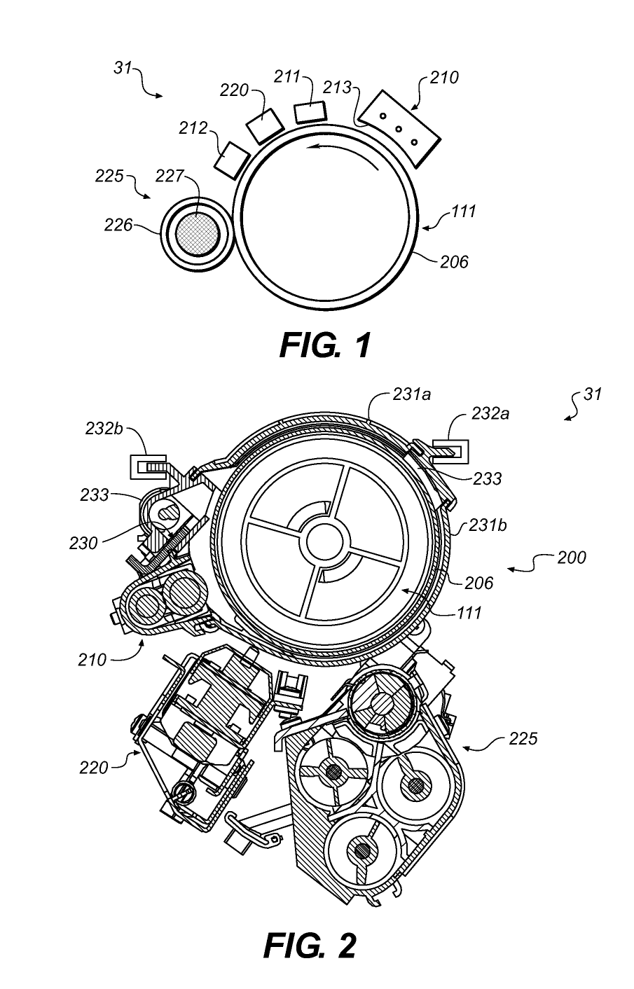

An imaging module consists of components to enable printing of a single color image. Multiple imaging modules may be assembled to enable printing of multiple color images. FIG. 1 shows details of a typical imaging module 31, which may be assembled with other imaging modules to enable color printing.

Within the imaging module 31 are various subsystems referred to collectively as imaging members but specifically referred to according to their function. Charging subsystem 210 uniformly electrostatically charges photoreceptor 206 of photoreceptive member 111, shown in the form of an imaging cylinder. Charging subsystem 210 may include a grid 213 having a selected voltage, or may be in the form of a charging roller with conductive properties.

Additional imaging members provided for control may be assembled around the various process elements of the respective printing modules. For example, meter 211 measures the uniform electrostatic charge provided by charging subsystem 210, and meter 212 measures the post-exposure surface potential within a patch area of a latent image formed from time to time in a non-image area on photoreceptor 206.

Image writer 220 is used to expose photoreceptor 206 and may be a light emitting diode (LED) array or other similar mechanisms or laser. Toning unit 225, comprising elements 226 and 227, is used to develop the latent image created by image writer 220 on photoreceptor 206. Cleaning unit 230 removes residual toner from photoreceptor 206 after transfer of the image to a secondary receiver. Other meters and components may be included.

Within the imaging module 31, periodic replacement of critical components is necessary to ensure proper function. It may be desirable to cluster multiple components to enable simultaneous replacement. Referring to FIG. 2, a replacement cartridge 200 within imaging module 31 is created consisting of a photoreceptive member 111, and additional imaging members such as a cleaning unit 230, and charging subsystem 210. These components are assembled into a cartridge and held in place with a plastic housing 233. Further, protective guards 231a and 231b are applied to the module, which serves to prevent damage to the photoreceptor 206 of the photoreceptive member 111. The replacement cartridge slides into the electrophotographic printer with guides 232a and 232b. Guides 232a and 232b are attached to the printer and help mount and align the replacement cartridge in the proper position.

Because of the proximity of various imaging members that interface with imaging module 31 and with replacement cartridge 200, it is necessary to have large areas of the photoreceptive member open during use. During insertion into the print engine, these open, unprotected areas could be damaged either mechanically or by light exposure. Therefore it is necessary to protect the photoreceptive member 111 from damage, either from extraneous light, fingerprints, or mechanical scrapes. The protective guards 231a and 231b, also referred to as a removable shield, slide into grooves within the replacement cartridge housing. These removable shields 231a and 231b stay in place when the cartridge is installed in the printer, and are removed by sliding the shields out of the housing to the front of the equipment after the replacement cartridge 200 is in place in the printer.

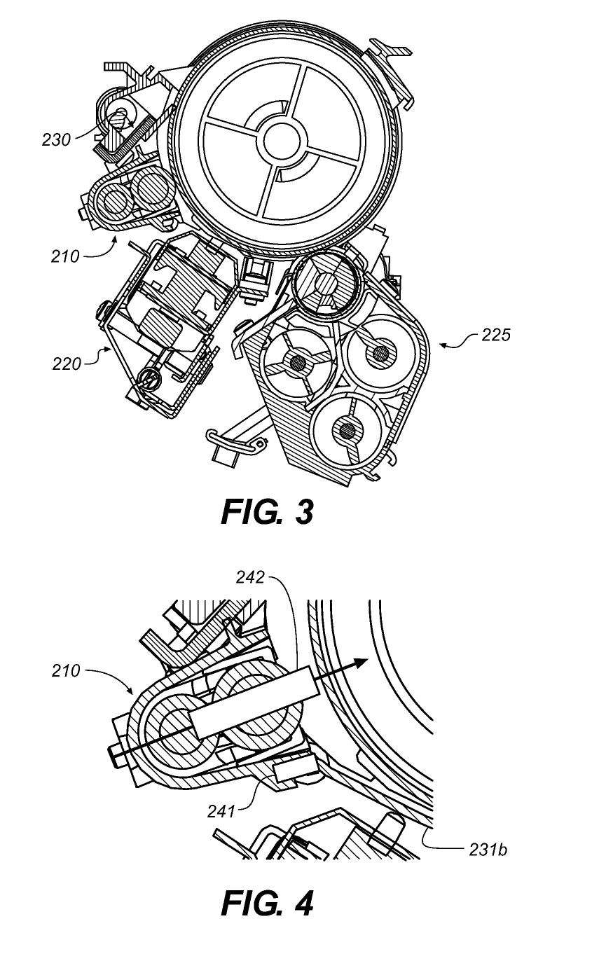

Referring now to FIG. 3 a replacement cartridge with shields 231a and 231b removed is shown. Some components that come in contact with the photoreceptor can cause damage to or be damaged by the photoreceptor 206. Attached to the protective guards 231a and 231b of imaging module 31 are actuators which push the charging subsystem 210 away from the photoreceptor 206 such that a gap is created. FIG. 4 shows a detail of a charging subsystem 210 separated from a photoreceptor 206, wherein separation is maintained by an actuation feature 241 mounted on protective guard 231b. Spring 242 provides actuation tension toward the photoreceptor.

Similar features may be used to actuate the cleaning unit 230, or other imaging members as required by the specific design. Referring again to FIG. 3, the imaging member remains clear of the photoreceptive member 111 until the protective guards 231a and 231b are removed from the unit. Because the guards are in place during shipment of replacement cartridges, the shield actuator prevents damage during long term storage. Additionally, if the particular electrophotographic printer design requires that the components in the machine be decoupled during periods of non-use the guards may be reinstalled to decouple the imaging member.

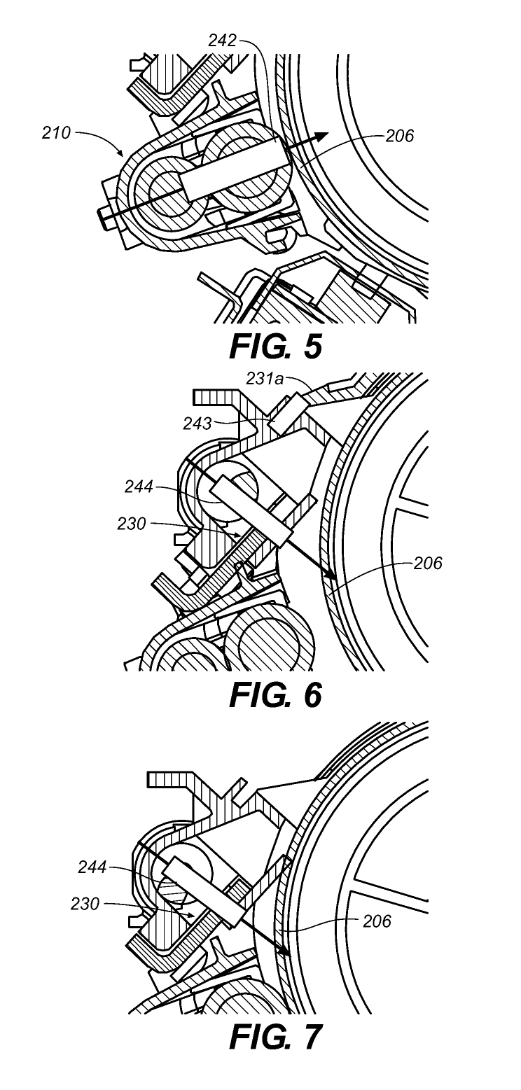

Referring now to FIG. 5, a detail of a charging subsystem 210 engaged to a photoreceptor 206, is shown with protective guard 231b removed. Spring 242 ensures contact of charging subsystem 210 to the photoreceptor 206. FIG. 6 shows a detail of a cleaning unit 230 separated from a photoreceptor 206, wherein separation is maintained by an actuation feature 243 mounted on protective guard 231a. Spring 244 provides actuation tension toward the photoreceptor.

Referring now to FIG. 7 a detail of a cleaning unit 230 engaged to a photoreceptor 206 is shown, with protective guard 231a removed. Spring 244 ensures contact of cleaning unit 230 to the photoreceptor 206.

It should be noted that various means of providing actuation force toward the photoreceptor may be used, and that the critical essence of the invention is the use of an actuation feature on said protective guards which enables the retraction and actuation of various imaging members through presence of said protective guards. In addition to the actuation of imaging members within the electrophotographic cartridge, similar means may be used to actuate imaging members such as toning unit 225 and image writer 220 from the photoreceptor 206.

Although the devices discussed require physical contact for proper performance, elements such as image writer 220, charger subsystem 210 if comprised of a corona charger and electrometers require a critical separation distance for proper function. For this consideration the removal of guards enables the actuation spring to pull the imaging member to a mechanical stop rather than the photoreceptor 206 acting as the mechanical stop.

In addition to the considerations discussed above a characteristic of the actuation feature is that when the guards are reinserted into the replacement cartridge, the various imaging members become separated from the photoconductor, allowing the removal of the replacement cartridge, or if separation only is needed to act as a countermeasure for a short term phenomena, can serve to do so within the machine.

The invention has been described in detail with particular reference to certain preferred embodiments thereof, but it will be understood that variations and modifications can be effected within the scope of the invention.

### PARTS LIST

31 imaging module
111 photoreceptive member
200 replacement cartridge
206 photoreceptor
210 charging subsystem
211 meter
212 meter
213 grid
220 image writer
225 toning unit
226 element
227 element
230 cleaning unit
231a protective guard (removable shield)
231b protective guard (removable shield)
232a guide
232b guide
233 plastic housing
241 actuation feature
242 spring
243 actuation feature
244 spring

1. An apparatus for engaging and disengaging an imaging member from a photoconductor comprising:
a shield enclosing the photoconductor;
a detent on the shield to maintain a space between the imaging member and the photoconductor;
wherein removing the shield allows the imaging member to move into contact with the photoconductor when the photoconductor and shield are inserted into an electrophotographic apparatus.

2. An apparatus as in claim 1 wherein the photoconductor and shield are cylindrical and coaxial.

3. An apparatus as in claim 1 wherein the shield is rigid.

4. An apparatus as in claim 1 wherein the photoconductor is comprised of organic materials.

5. An apparatus as in claim 1 wherein the shield portion interacts with detents on the imaging member to hold the imaging member always from the photoconductor.

6. An apparatus as in claim 1 wherein the imaging member is a charging roller or a cleaning blade or development station or image writer or process control module or corona charger transfer station.

7. An apparatus as in claim 1 wherein imaging member is spring-loaded for contact with the photoconductor.
